(19) United States
(12) Patent Application Publication
(10) Pub. No.: US 2006/0112621 A1
(43) Pub. Date: Jun. 1, 2006

(54) Landscape tent

(76) Inventor: Janet White, Deltona, FL (US)

Correspondence Address: EDWARD M. LIVINGSTON, PA, 963 TRAIL TERRACE DRIVE, NAPLES, FL, 34103, US

(21) Appl. No.: 10/989,819

(22) Filed: Nov. 16, 2004

(51) Int. Cl. A01G 13/02

(52) U.S. Cl. 47/31

(57) ABSTRACT

A landscape tent (1) having a flexible memory frame (2), a top panel (7) and numerous side panels (3) to surround various-sized plants (4), (9) and (11). The panels (3) and (7) are bordered by the memory frame (2), which is preferably made of wire, and filled in with an open-weave material to allow air to pass through the tent (1). Anchor loops (5) are located at the base (12) of the tent (1) to allow a user to secure the tent (1) to the ground. The use of the present invention will not only protect plants (4), (9) and (11) from the elements, such as wind, rain, snow, hail, sleet and frost, but will also not cause damage the plants (4), (9) and (11) because the tent (1) does not touch the plants (4), (9) and (11).

### BACKGROUND OF THE INVENTION

This invention relates to landscape tents, more specifically, a landscape tent that surrounds plants, shrubs and trees in order to protect them from the elements.

Currently, there are many methods and devices for protecting treasured plants, shrubs, trees and the like from dangerous elements, such as wind, rain, snow and frost. By far the most common method is to simply place a piece of plastic over the plant and tie the plastic to the tree. However, many people do not realize that they are, in fact, damaging their plant by doing so as the plastic may stick to the plant, and the plants are not allowed to breathe. In addition, if a person does not properly tie down the plastic, wind could blow the plastic off the plant.

Other currently used devices include plant protector shields which, although shield the plant from the natural elements, still expose a large part of the plant to the elements in various areas. Thus, although the top portion of the plant may be protected, the bottom portion may still be subject to wind, rain, snow and frost. In addition, these plant protector shields are difficult to use as a person must maneuver the shield in various positions before setting the shield in its protective plant position.

Thus, the need exists for a landscape tent that is easy to use and protects the landscaping, be it plants, shrubs, trees and the like, from the elements without touching the landscaping.

The relevant prior art includes the following patents:

| Pat. No. | | |
|---|---|---|
| (U.S. unless stated otherwise) | Inventor | Issue Date |
| 6,014,837 | Morgan | Jan. 18, 2000 |
| 5,800,067 | Easter | Sep. 1, 1998 |
| 4,825,892 | Norman | May 2, 1989 |
| 6,625,924 | Lundgreen | Sep. 30, 2003 |
| 5,816,278 | Kim | Oct. 6, 1998 |
| 4,128,104 | Corey | Dec. 5, 1978 |
| 6,267,129 | Zheng | Jul. 31, 2001 |
| 6,305,396 | Zheng | Oct. 23, 2001 |
| 5,411,046 | Wan | May 2, 1995 |

### SUMMARY OF THE INVENTION

The primary object of the present invention is to provide a landscape tent that shelters plants, shrubs, trees and the like without touching the same.

A further object of the present invention is to provide a landscape tent that is easy to use.

An even further object of the present invention is to provide a landscape tent that is durable.

Another object of the present invention is to provide a landscape tent that is flexible.

The present invention fulfills the above and other objects by providing a landscape tent comprising an open-weave cloth, a memory frame and anchor loops located at the bottom of the tent. The open-weave cloth allows air to pass through, thus allowing the covered plant to receive fresh air. The memory frame, preferably made of wire, is flexible so it can be folded into a compact size for storage. The anchor loops allow a person to use stakes to secure the tent into the ground. Because the tent surrounds the plant, rather than resting on it, users need not worry about the tent itself damaging the plant.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a perspective view of a first embodiment of the landscape tent of the present invention sheltering a small plant;

FIG. 2 is a downward-looking view of the embodiment of FIG. 1;

FIG. 3 is an upward-looking view of the embodiment of FIG. 1;

FIG. 4 is a perspective view of a second embodiment of the landscape tent of the present invention sheltering a tall plant;

FIG. 5 is a perspective view of a third embodiment of the landscape tent of the present invention sheltering a row of small plants;

FIG. 6 is a perspective view of the embodiment of FIG. 1 with a light bulb flap; and

FIG. 7 is a side view of the embodiment of FIG. 1 in a folded condition for storage.

### DESCRIPTION OF THE PREFERRED EMBODIMENTS

For purposes of describing the preferred embodiment, the terminology used in reference to the numbered components in the drawings is as follows:

| | |
|---|---|
| 1. landscape tent | 7. top panel |
| 2. memory frame | 8. open portion |
| 3. side panel | 9. row of plants |
| 4. small plant | 10. light bulb flap |
| 5. anchor loop | 11. tall plant |
| 6. stake | 12. base of tent |

With reference to FIG. 1, a perspective view of a first embodiment of the landscape tent 1 of the present invention sheltering a small plant 4 is shown. The landscape tent 1 has a memory frame 2, preferably made of a lightweight wire, which forms a border for a top panel 7 and side panels 3 of the tent 1. The top panel 7 and side panels 3 are connected to each other by the common joints of the memory wire 2. Each panel 7 and 3 has an open-weave cloth material in the areas within the memory frame 2 of each panel 7 and 3. The tent 1 is placed over a small plant 4 and is secured to the ground by inserting stakes 6 into anchor loops 5. Because the memory frame 2 continues around the base of the tent 1, a cylindrical tent 1 is created, thereby protecting the plant 4 from the elements without touching the plant 4.

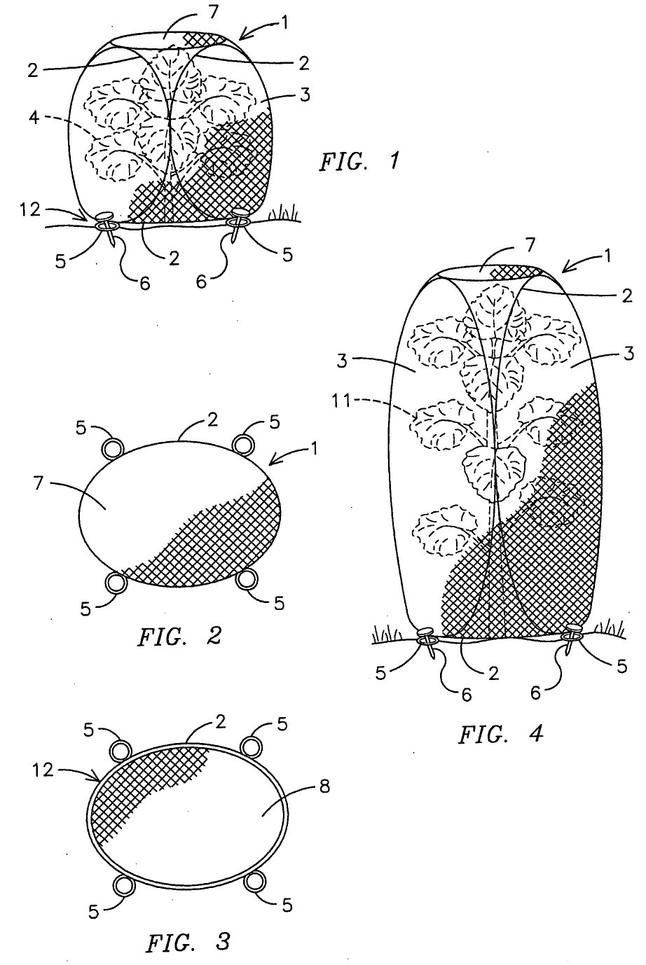

In FIG. 2, a downward-looking view of the embodiment of FIG. 1 is shown. The top panel 7 of the tent 1 utilizes an open-weave material within the memory frame 2 to allow air to access the plant 4.

In FIG. 3, an upward-looking view of the embodiment of FIG. 1 is shown. The memory frame 2 is shaped so as to be identical to the top panel 7, thereby creating a cylindrically-shaped tent 1. However, whereas the top panel 7 utilizes an open-weave material within the top panel 7 memory frame 2, the memory frame 2 of the base of the tent 12 has an open portion 8 for acceptance of the plant 4.

With respect to FIG. 4, a perspective view of a second embodiment of the landscape tent 1 of the present invention sheltering a tall plant 11 is shown. The second embodiment of the landscape tent 1 has all of the features as described above. However, the side panels 3 of the second embodiment are taller so as to accommodate a tall plant 11.

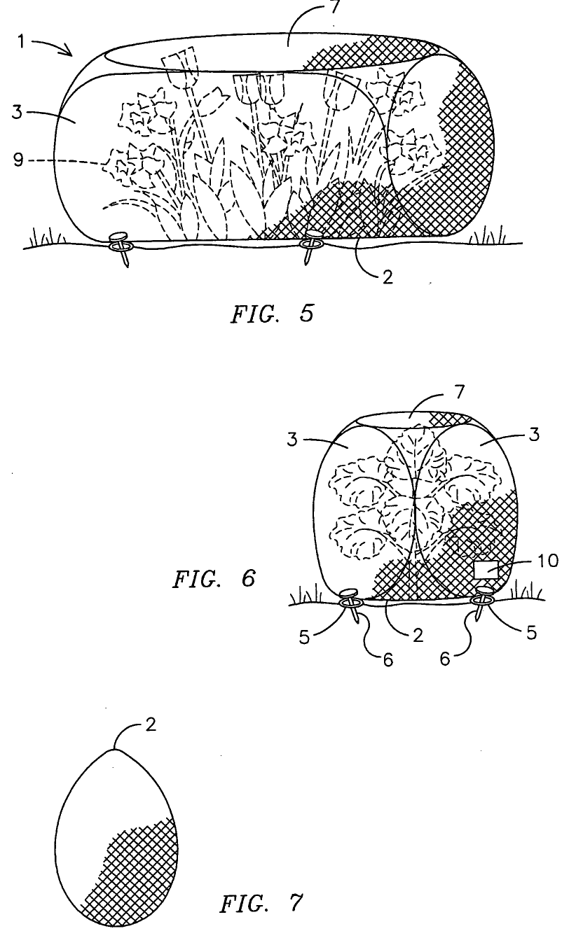

In FIG. 5, a perspective view of a third embodiment of the landscape tent 1 of the present invention sheltering a row of small plants 9 is shown. The third embodiment of the landscape tent 1 has all of the features as described above. However, the side panels 3 of the third embodiment are longer so as to accommodate a row of plants 9.

With respect to FIG. 6, a perspective view of the embodiment of FIG. 1 with a light bulb flap 10 is shown. The light bulb flap 10 is located on a side panel 3 of the tent 1 to allow a user to insert a light bulb into the tent 1 to warm a plant 4.

Finally, FIG. 7 shows a side view of the embodiment of FIG. 1 folded. Because the tent 1 is made of an open-weave material and utilizes a flexible memory frame 2, a user can quickly and easily fold the tent 1 in itself for easy storage. The user simply removes the stakes 6 from the ground and anchor loops 5, lifts the tent 1 off the plant 4, 9, or 11 and twists memory frame 2 so the panels 3 and 7 fold onto one another.

Various designs for landscapes tents can be used wherein the landscape tents have multiple panels of various shapes and sizes.

Although only a few embodiments of the present invention have been described in detail hereinabove, all improvements and modifications to this invention within the scope or equivalents of the claims are included as part of this invention.

I claim:

1. A landscape tent comprising:
at least one side panel;
at least one top panel attached to said at least one side panel; and
a memory frame circumventing said at least one side panel and said at least one top panel wherein said memory frame forms a base opposite said at least one top panel.

2. The landscape tent of claim 1 wherein: said base has anchor loops.

3. The landscape tent of claim 1 wherein: said at least one side panel is made of an open-weave material; and said at least one top panel is made of an open-weave material.

4. The landscape tent of claim 1 wherein: said memory frame is wire.

5. The landscape tent of claim 1 wherein: said at least one side panel has rounded comers.

6. The landscape tent of claim 1 wherein: said at least one side panel has angled comers.

7. The landscape tent of claim 1 wherein: said at least one top panel has rounded comers.

8. The landscape tent of claim 1 wherein: said at least one top panel has angled comers.

9. The landscape tent of claim 1 wherein: said base is open.

10. The landscape tent of claim 1 wherein: at least one flap is located on said at least one side panel.
